(19) United States
(12) Patent Application Publication
(10) Pub. No.: US 2006/0203013 A1
(43) Pub. Date: Sep. 14, 2006

(54) Display panel rotating apparatus

(75) Inventor: Chih Chong Chuo, Hsinchu (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/135,322

(22) Filed: May 24, 2005

(30) Foreign Application Priority Data
Mar. 11, 2005 (TW) 094107500

(51) Int. Cl. G09G 5/00

(52) U.S. Cl. 345/649

(57) ABSTRACT

A display panel rotating apparatus is used for rotating a display panel, and the display panel has a first fixing element and a second fixing element used for being connected with the rotating apparatus. The apparatus comprises a base and a first and a second driver sets moved on the base, in which the first and the second driver sets are respectively pivotally connected with the first and the second fixing elements to form a first and a second rotating centers so that the display panel takes either the first or the second rotating center as a axle center to rotate through the driving of the first or the second driver set.

### DISPLAY PANEL ROTATING APPARATUS

This Non-provisional application claims priority under 35 U.S.C. §119(a) on Patent Application No(s). 094107500 filed in Taiwan, Republic of China on Mar. 11, 2005, the entire contents of which are thereby incorporated by reference.

### BACKGROUND OF THE INVENTION

1. Field of the Invention

The present invention relates to a rotating apparatus, and more particularly to a rotating apparatus used for rotating a display panel in a level direction.

2. Description of Related Art

As the technique is being developed, a display system has already broadly been utilized in vehicle; such a display system is generally installed on a dashboard between the driver seat and the front passenger seat to allow the driver or passenger to be able to obtain firsthand vehicle driving information displayed on the panel of the display system.

Now please refer to FIG. 1. The current display system comprises a mainframe M, a display panel set P and a case 10, in which the mainframe M and the display panel set P are respectively accommodated in the space of the case 10 with a unified specification inserted in the dashboard. And, the display panel set P comprises a sliding base P1, a displayer P2, a rotator set P3, and driver sets (not shown in the figure). The displayer P2 is pivotally connected to the front end of the sliding base P1 and is controlled by the rotator set P3. After the displayer P2 is driven out of the case 10 by the driver set, the displayer P2 is then rotated upward in an angle of 90° from a level state through the rotator set P3 to allow the driver or the passenger to read the message shown on the displayer P2.

However, the vision angle of a general liquid crystal display may not exceed an angle of 45° from the normal axis of the display penal. But, since the display panel in a vehicle is mainly installed on the dashboard between the driver seat and front passenger seat, an image viewing quality is improper if a viewing angle is not adjusted properly. Therefore an apparatus allowing the display panel to be rotated rightward or leftward has been developed and disclosed in, for example, U.S. Pat. No. 6,731,350 entitled “Vehicle Mounted Display System”.

In the patent, a driver setting on a sliding base for driving the sliding base is divided into a first driver set and a second driver set which are respectively disposed at the two sides of the sliding base. Each driver set comprises a gear train and a driving motor for driving the gear train. The first driver set and the second driver set are moved forward by the operation of the driving motor and the gear train and also push the display panel to move forward out of the case. Then, the display panel is raised 90° upward from a level state by the rotator set mentioned above. After raising the display panel, the first and the second driver sets on the sliding base are controlled to move forward or backward, and the display panel is rotated to face either the driver or the passenger.

According to the above rotating structure, the rotating center of the display panel is located at the center of the sliding base. In order to rotate the display penal, when one driver set among them is moved forward, another driver set must be moved backward relatively, and the rotating deviation amount of the display panel is equal to the moving amount of the first and the second driver sets. Therefore, the panel can only be rotated at a small margin under the space limitation in the standard case or the vehicle.

Besides, for preventing the display panel elevated upward with 90° from interfering with the case while being rotated and for increasing the margin of the rotating deviation of the panel, a sliding chassis is further moveably installed in the case. The sliding chassis is first pulled out the case to increase the moving space of the first and the second driver sets so that the rotating margin of the panel is enlarged and the interference between the display panel and the case is prevented.

In above structure, a sliding chassis structure is incorporated, therefore, the numbers of the entire components are increased and the structure is more complex so that the production cost is increased. Besides, the sliding base and the panel are further extended out of the case so that the panel may easily be struck by external objects causing the damage of the panel.

### SUMMARY OF THE INVENTION

In view of the defects mentioned above, one object of the present invention is to provide a display panel rotating apparatus, in which the display panel can be rotated in a larger angle, a space can be minimized and the rotating margin of the display panel can be increased.

For attaining to the object mentioned above, the present invention proposes a display panel rotating apparatus, the display panel having a first fixing element and a second fixing element used for being connected with the rotating apparatus, the apparatus comprising:
a base;
a first driver set, movably disposed on the base and having a first connecting element; and
a second driver set, movably disposed on the base and having a second connecting element;
in which the first fixing element is pivotally connected on the first connecting element, the second fixing element is pivotally connected on the second connecting element and the first fixing element is movable relatively to the first connecting element.

According to the rotating apparatus of the present invention, a long-shape hole is provided on the first fixing element and a pivotal shaft is disposed at the front end of the first connecting element and engaged in the long-shape hole. When the second driver set drives the display panel to rotate by taking the pivotal shaft as a rotating center, the pivotal shaft is moved in the long-shape hole.

As mentioned above, because the long-shape-hole is provided on the first fixing element, when the first or the second driver set drives the display panel to rotate in a direction, there provides a tolerance space for the display panel being rotated smoothly.

According to the rotating apparatus, an axial hole is provided on the second fixing element and a pivotal shaft is provided at the front end of the second connecting element and engaged in the axial hole. The first driver set can drive the panel to rotate around the pivotal shaft.

According to the rotating apparatus of the present invention, the first and the second driver sets also respectively have a motor and driving gear train, and one pair of racks disposed on the base are respectively engaged with the driving gear trains. The driver set can be moved along the racks in a fixed direction on the base.

According to the rotating apparatus of the display panel rotating apparatus of the present invention, the longer the length of the connecting element is, the larger the maximum rotating angel of the display panel is.

For attaining to the objects mentioned above, the present invention also proposes another rotating apparatus used for rotating a display panel, in which the display panel has a first fixing element and a second fixing element used for connecting with the rotating apparatus, the apparatus comprises:

a base having a first and a second guide grooves thereon;

a first driver set movably disposed on the base and having a first connecting element;

a second driver set movably disposed on the base and having a second connecting element;

a first interlocking element pivotally connected on the first connecting element, one end thereof being engaged in the first guide groove and moved along the first guide groove, another end thereof being pivotally connected to the first fixing element; and

a second interlocking element pivotally connected to the second connecting element, one end thereof being engaged in the second guide groove and moved along the second guide groove, another end thereof being pivotally connected to the second fixing element.

According to the rotating apparatus of the present invention, a long-shape hole is provided on the first fixing element and a pivotal shaft is disposed on the front end of the first interlocking element. When the second driver set rotates the display panel by taking the pivotal shaft as a rotating center, the pivotal shaft is moved in the long-shape hole by engaging the pivotal shaft in the hole.

As mentioned above, because the long-shape hole is provided on the first fixing element, when the first or the second driver set drives the display panel to rotate in a direction, there provides a tolerance space for the display panel being rotated smoothly.

According to the rotating apparatus, an axial hole is provided on the second fixing element and a pivotal shaft is provided at the front end of the second connecting element and engaged in the axial hole. The first driver set can drive the panel to rotate around the pivotal shaft.

According to the rotating apparatus of the present invention, the first and the second driver sets also respectively have a motor and driving gear train, and one pair of racks disposed on the base are respectively engaged with the driving gear trains. The driver set can be moved along the racks in a fixed direction on the base.

According to the rotating apparatus of the present invention, the first and the second guide grooves each has an oblique guide groove at its front part and a straight groove at its middle part and the rear part.

Therefore, the interlocking elements are driven to move along the oblique guide groove to rotate the display panel with a larger angle.

According to the rotating apparatus of the present invention, an included angle is formed between the rear part and the front part of the interlocking element. The larger the included angle is, the larger the maximum rotating angle of the display panel is.

### BRIEF DESCRIPTION OF THE DRAWINGS

The present invention can be more fully understood by reference to the following description and accompanying drawings, in which:

FIG. 1 is a schematic view showing a conventional vehicle display system;

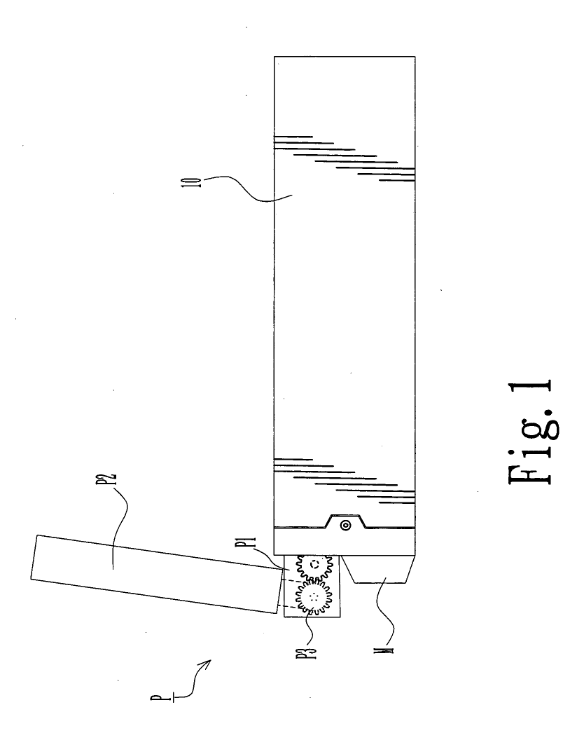

FIG. 2 is an explosive view showing a display panel rotating apparatus of a first preferred embodiment of the present invention;

FIG. 3 is a schematic view showing that a display panel is rotated anticlockwise by a display panel rotating apparatus of a first preferred embodiment of the present invention;

FIG. 4 is a schematic view showing a display panel rotating apparatus of a first preferred embodiment of the present invention wherein the display panel is rotated clockwise;

FIG. 5 is a flow chart showing an operation procedure of a display panel rotating apparatus of a first preferred embodiment of the present invention;

FIG. 6 is a flow chart showing another operation procedure of a display panel rotating apparatus of a first preferred embodiment of the present invention;

FIG. 7 is an explosive view showing a display panel rotating apparatus of a second preferred embodiment of the present invention;

FIG. 8 is a schematic view showing a combination of a display panel and a display panel rotating apparatus of a second preferred embodiment according to the present invention; and

FIG. 9 is a schematic view showing that a display panel is rotated anticlockwise by a display panel rotating apparatus of a second preferred embodiment of the present invention.

### DETAILED DESCRIPTION OF THE PREFERRED EMBODIMENTS

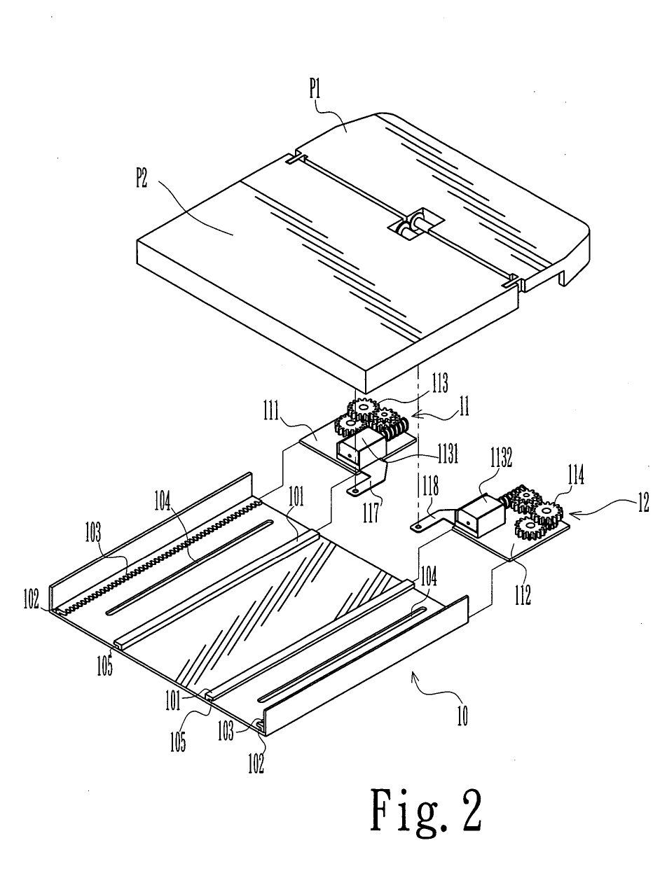

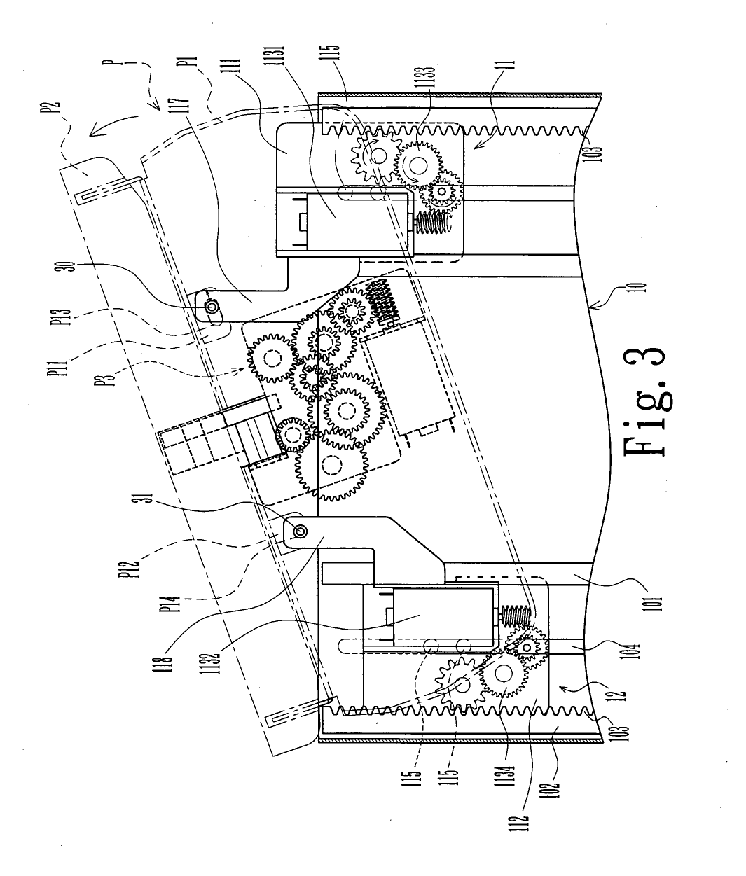

Please refer to FIGS. 2 and 3. FIG. 2 is an explosive view showing a display panel rotating apparatus of a first preferred embodiment according to the present invention and FIG. 3 is a schematic view showing that a display panel is rotated anticlockwise by the display panel rotating apparatus of a first preferred embodiment according to the present invention. A display panel rotating apparatus of the first embodiment comprises a base 10 and a first and a second driver sets 11 and 12, in which a pair of first guide rails 101 and a pair of second guide rails 102 are respectively disposed on the middle part of the surface and the two flank sides of the base 10. A rack 103 is disposed at one side of each second guide rail 102, and a long guide hole 104 is disposed on the base 10 between each pair of the first and the second guide rails 101 and 102. Besides, a distance is kept between each guide rail and the base 10 such that a guide trench 105 is formed between the surface of the base 10 and the guide rail for being engaged with the driver sets 11 and 12. Therefore, the first and the second driver sets 11 and 12 can be prevented from separating from the surface of the base 10 due to the external shock.

The first driver set 11 includes a first platform 111 and a motor set 113, in which at least one pair of guide pins 115 are disposed on the bottom of the first platform 111, as FIG. 3 shows. Similarly, the second driver set 12 includes a second platform 112 and a motor set 114, in which at least one pair of guide pins 115 are disposed on the bottom of the second platform 112, as FIG. 3 shows. Therefore, the guide pins 115 are directly engaged in the long guide hole 104 between the first and the second guide rails 101 and 102 when the two flank sides of the platform are inserted into the guide trenches 105 of the first and the second guide rails 101 and 102 to allow the first and the second platforms 111 and 112 to be guided along the long guide holes 104 in an axial direction on the base 10.

Besides, connecting elements 117 and 118 are respectively extended from the relative sides of the first and the second platforms 111 and 112, and the front ends of the connecting elements 117 and 118 are respectively pivotally connected to a display panel set P. The display panel set P comprises a sliding base P1 and a displayer P2, in which the displayer P2 is pivotally connected to one side of the sliding base P1 and a first and a second fixing elements P11 and P12 are disposed at the low surface of the sliding base P1, as FIG. 3 shows. A first and a second pivoting holes P13 and P14 are respectively disposed on the fixing elements P11 and P12 and respectively pivotally connected to pivoting rods 30 and 31 disposed on the connecting elements 117 and 118 so that the display panel set P can take either the pivoting rod 30 or pivoting rod 31 as a first or a second rotating center to rotate. The first pivoting hole P13 is a long-shaped hole, and the pivoting rod 30 is engaged in the long-shaped hole P13 and can move within the long-shaped hole P13 so that the displayer P2 can take the first or the second rotating center as an rotating center to be smoothly rotated clockwise or anticlockwise.

In this invention, the terms “clockwise” and “anticlockwise” respectively mean the directions which are clockwise and anticlockwise when viewing the FIGS. 3, 4, 8, and 9.

Furthermore, driving motor sets 113 and 114 are further respectively installed on the first and the second platforms 111 and 112; the driving motor sets 113 and 114 respectively include motors 1131, 1132 and gear trains 1133, 1134, in which the power outputting shafts of the motors 1131 and 1132 are respectively engaged with the gear trains 1133 and 1134 and other sides of the gear trains 1133 and 1134 are respectively engaged with racks 103 provided at the inner sides of the second guide rail 102 to allow the first and second platforms 111 and 112 to be driven by the driving motor sets 113 and 114 to move on the base 10 in an axial direction.

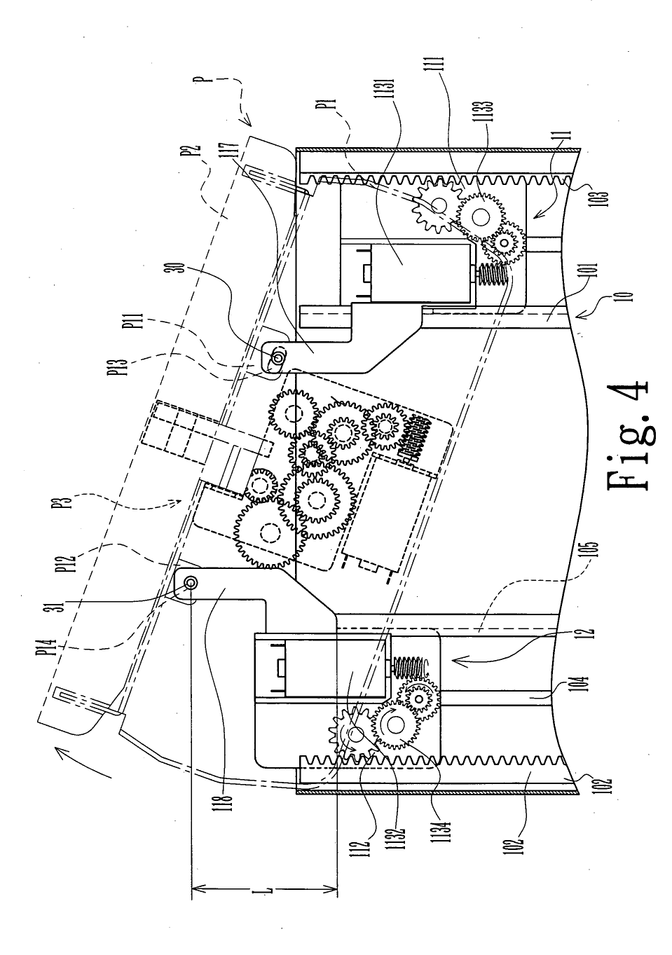

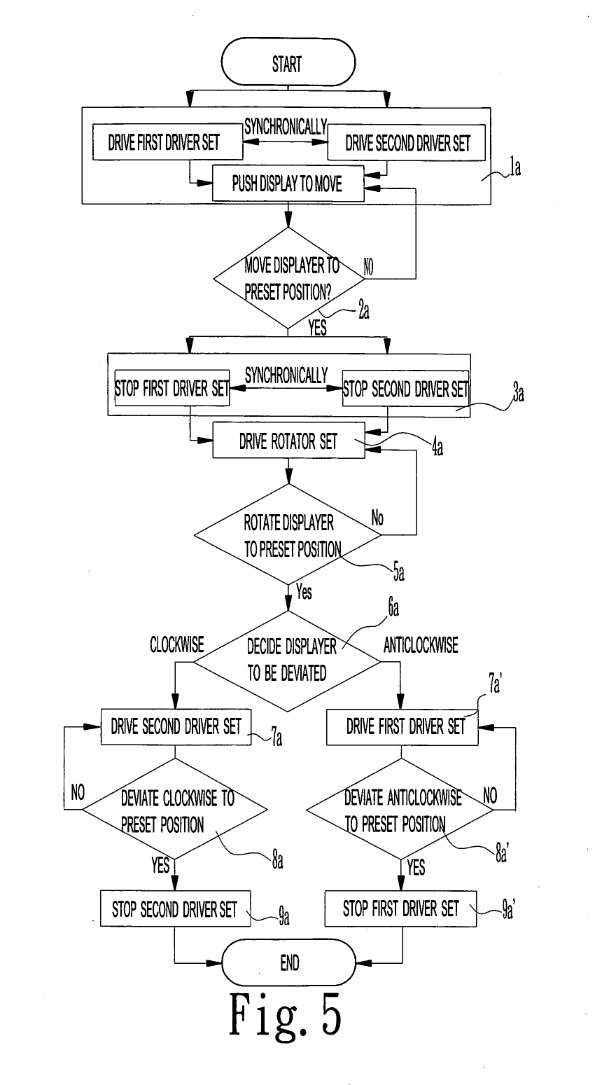

Please refer to FIGS. 3 to 5. FIGS. 4 and 5 respectively are a schematic view and a flow chart, showing that a display panel is rotated clockwise by a display panel rotating apparatus of a first preferred embodiment according to the present invention. According to the display panel rotating apparatus of the embodiment, the display panel set P is accommodated in the base 10 (not shown in the figure) before the first and the second driver sets 11 and 12 are driven.

When the user wants to use the display panel, the motors 1131 and 1132 are first actuated synchronically to rotate and move the first and the second driver sets 11 and 12 synchronically along the long guide holes 104 thereby to push the display panel set P out of the base 10 (Step 1a). And, when the displayer P2 is pushed out to a predetermined position (Step 2a), the first and the second driver sets 11 and 12 are then stopped at the same time. Thereafter, a rotator set P3 on the sliding base P1 is then actuated immediately (Step 4a) to rotate the displayer P2 pivotally connected to the front end of the sliding base P1 to stand up from the level direction (Step 5a).

Next, the displayer P2 can be chosen to rotate clockwise or anticlockwise depending on the user's commend (Step 6a) to cause the displayer P2 to be faced to the viewing direction of the user. If the user chooses to rotate the displayer P2 clockwise as FIG. 4 shows, the second driver set 12 is again driven to move forward along the long guide hole 104 (Step 7a); the first driver set 11 is kept at a standstill state. As the second driver set 12 moves forward, the sliding base P1 accompanying with the displayer P2 is rotated clockwise synchronically around the first rotating center (i.e. pivoting rod 30), as FIG. 4 shows. And, when the displayer P2 is rotated to a predetermined position (Step 8a), the second driver set 12 is then stopped immediately (Step 9a) so that the passenger that sits at the right side of the central dashboard to be able to read the message on the displayer P2 with a better angle of view.

In a similar way, when the displayer P2 is chosen to rotate anticlockwise, the first driver set 11 is again driven to move forward along the long guide hole 104 (Step 7a′) to push another side of the sliding base P1 so that the sliding base P1 and the displayer P2 are rotated anticlockwise around the second rotating center (i.e. pivoting rod 31), as FIG. 3 shows. When the displayer P2 is rotated to a predetermined position (Step 8a′), the first driver set 11 is then stopped immediately (Step 9a′) so as to allow a passenger or driver that sits at the left side of the central dashboard to read the message on the displayer P2.

According to the display panel rotating apparatus of the embodiment, the length of both of the connecting elements 117 and 118 is L, as FIG. 4 shows. The length L decides the maximum rotating angle that the displayer P2 can be rotated after it out of the base 10 completely.

According to the display panel rotating apparatus of the embodiment, when the first or the second driver set 11 or 12 pushes the displayer P2 to rotate toward one direction, because at least one of the first and the second pivoting holes P11 and P12 is a long-shaped hole, when the first or the second driver set 11 or 12 is driven to move at a fixed direction (i.e. the driver set itself is not rotated like the sliding base does) and the sliding base P1 takes the first or the second rotating center as a rotating center to rotate, the pivoting rod 30 is moved in the long-shaped hole P13 relatively to provide a rotating space, so that the sliding base P1 can be smoothly rotated.

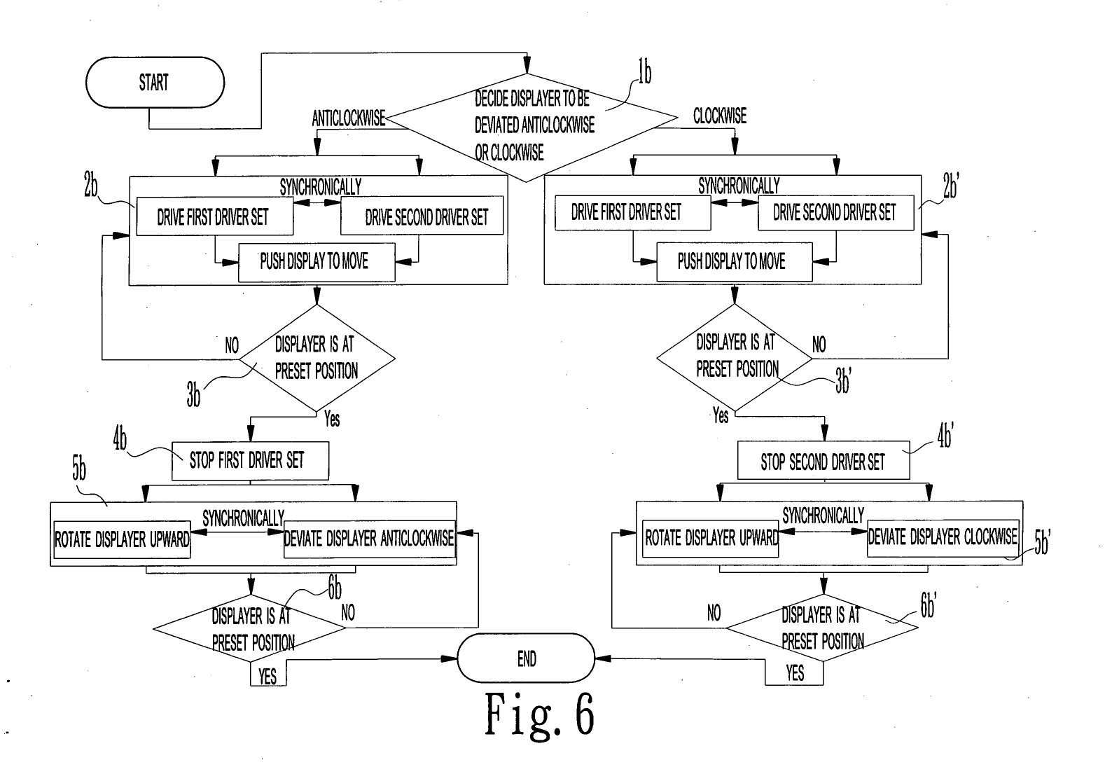

Please refer to FIG. 6. FIG. 6 is a flow chart showing another operation of a display panel rotating apparatus of a first preferred embodiment according to the present invention. Before the first and the second driver sets 11 and 12 are driven synchronically, a user can decide the rotating direction of the displayer P2 (Step 1b) and then drives the first and the second driver sets 11 and 12 synchronically (Step 2b (2b′)) to move the displayer P2 to a location (Step 3b (3b′)). The user can directly control the first and the second driver sets 11 and 12 to stop or continue driving forward according to the predetermined rotating direction (Step 4b (4b′)). In the meantime, the continuously moving driver set 11 (12) is synchronically operated accompanying with the rotators set P3 on the sliding base P1 to rotate the displayer P2 to stand up from the original level direction and to face the predetermined rotating direction (Step 5b (5b′)). Whereby, the operation processes can be effectively simplified and the time for waiting for the operation of the rotating of the displayer P2 is reduced.

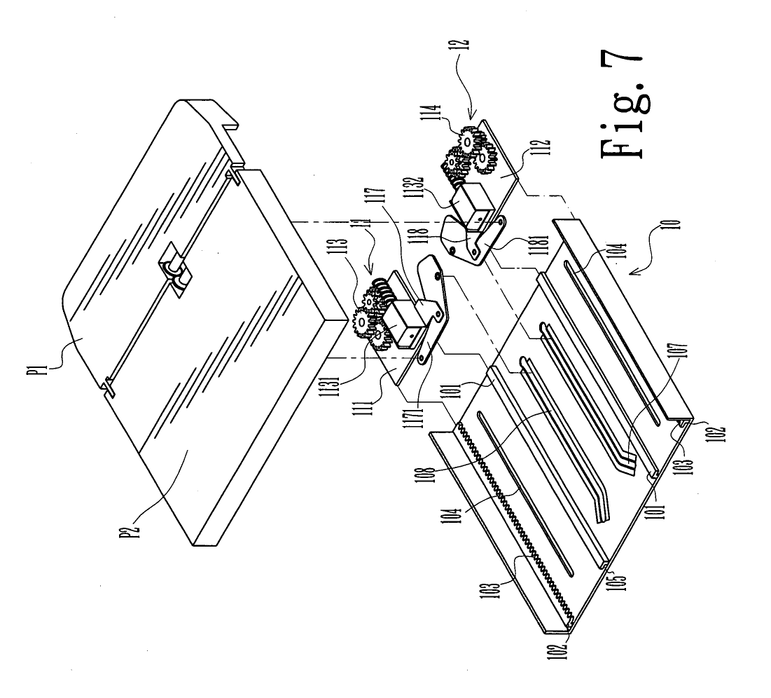

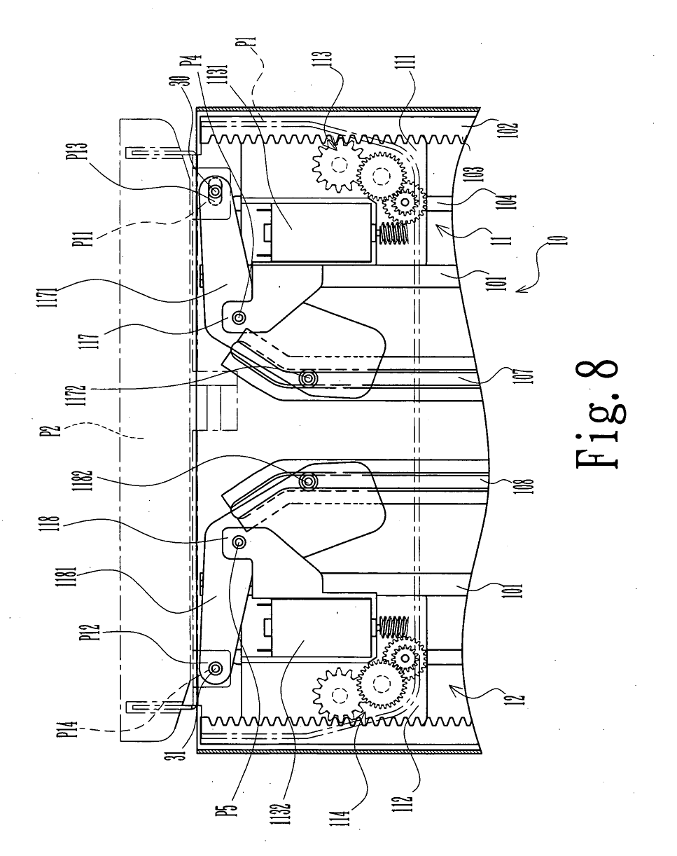

Please refer to FIGS. 7 and 8. FIG. 7 and FIG. 8 are respectively an explosive view and a schematic view showing a display panel rotating apparatus of a second preferred embodiment according to the present invention. A display panel rotating apparatus of the second embodiment includes a base 10, a first and a second driver sets 11 and 12, and a pair of first and second interlocking elements 1171 and 1181, in which a pair of first and second guide rails 101 and 102 are respectively disposed on the middle and the side of the base 10 as the first embodiment does. A rack 103 is disposed at the flank side of the second guide rail 102. Two long guide holes 104 are respectively disposed on the base 10 between the first and the second guide rails 101 and 102. Besides, each guide rail is kept a distance from the surface of the base 10 to from a guide groove 105 for engaging with the driver set.

The first driver set 11 includes a first platform 111 and a driving motor set 113, in which one pair of guide pins 115 are respectively disposed on the bottom of the platform 111. The second driver set 12 includes a second platform 112 and a driving motor set 114, in which one pair of guide pins 115 are respectively disposed on the bottom of the platform 112. The guide pins 115 are respectively engaged in the long guide holes 104 between the first and the second rails 101 and 102 when the platforms 111 and 112 are respectively engaged in the guide grooves 105 so as to guide the first and the second platforms 111 and 112 moving along the long guide holes 104 on the base 10. Besides, connecting elements 117 and 118 are respectively extended from the relative sides of the first and the second platforms 111 and 112.

Besides, a first and a second guide grooves 107 and 108 are disposed on the base 10. The middle parts and rear parts of this pair of guide grooves are straight grooves parallel to each other, but the front ends thereof are extended to the sides of the base 10 in opposite directions to form oblique guide grooves of the first and second guide grooves 107 and 108.

The front end and the rear end of each of the interlocking elements 1171 and 1181 form a fixed included angle θ. The middle positions of the interlocking elements 1171 and 1181 are respectively pivotally connected to the front ends of the connecting elements 117 and 118. The front ends of the interlocking elements 1171 and 1181 respectively have a first pivoting rod 30 and a second pivoting rod 31. The first and second pivoting rods 30 and 31 are respectively pivotally connected in a first and a second pivoting holes P13 and P14 respectively provided on a first and a second fixing element P11 and P12 of the sliding base P1. The display panel set P selectively takes the first or the second pivoting rods 30 and 31 as the rotating center to rotate clockwise or anticlockwise. Furthermore, the rear ends of the interlocking elements 1171 and 1181 respectively have a raised column 1172 and 1182. The raised columns 1172 and 1182 are respectively engaged in the first and the second guide grooves 107 and 108 and can be moved along the guide grooves engaged therewith.

Besides, the first pivoting hole P13 is a long-shaped hole. Therefore, when the display panel set P takes the first or the second pivoting rods 30 and 31 as a rotating center to rotate, the first fixing element P11 is not only rotated relative to the interlocking element 1171 but also moved slightly relative to the interlocking element 1171. So that the display panel set P is rotated smoothly and the interference is not generated.

According to the embodiment, when the first driver set 11 is driven to move forward, the connecting element 117 will drive the interlocking element 1171 to move forward at the time. Besides, the interlocking element 1171 is also rotated relative to the connecting element 117 by the movement of the raised column 1172 along the oblique guide groove of the first guide groove 107 to rotate the display panel set P anticlockwise. And, the display panel set P is rotated clockwise in a same manner, wherein the second driver set 12 is driven to move forward.

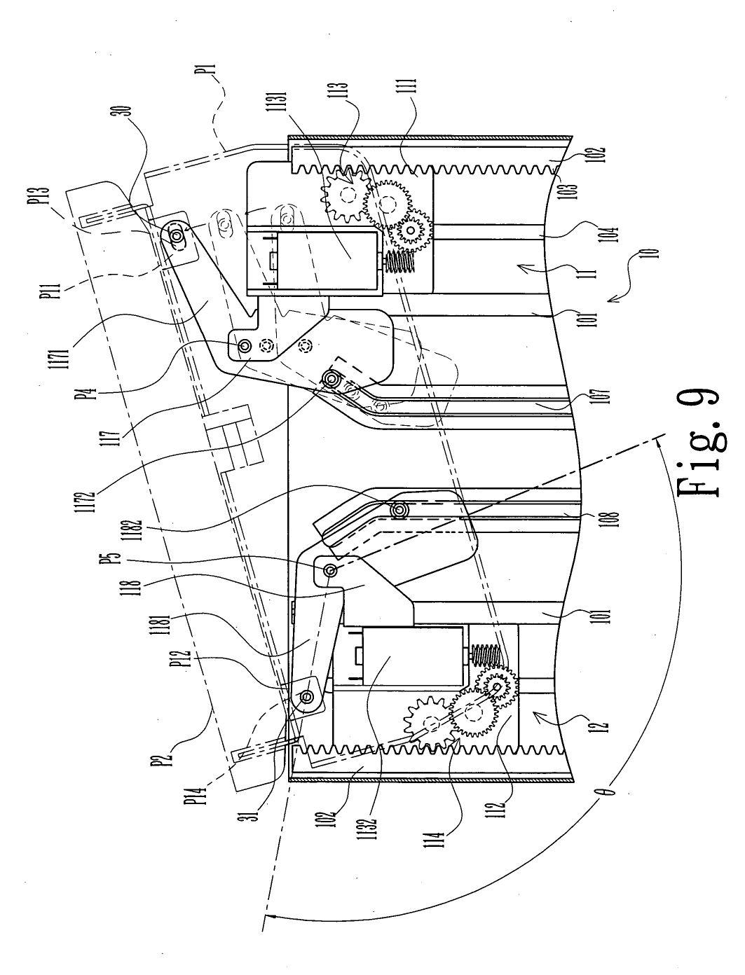

Please refer to FIGS. 8 and 9. FIGS. 8 and 9 are schematic views showing the combinations of a display panel and a display panel rotating apparatus before and after rotation according to a second preferred embodiment. When the display panel is to be used, the first and the second driver sets 11 and 12 are driven synchronically and the displayer P2 is pushed out from the base 10 to a fixed position. Meanwhile, the raised columns 1172 and 1182 disposed on the interlocking elements 1171 and 1181 are also moved along the first and second guide grooves 107 and 108 to position at the intersection of the straight guide and oblique guide, as FIG. 8 shows wherein the displayer P2 has been raised up from a level position after being pushed out from the base 10 to a fixed position.

If the displayer P2 is to be rotated anticlockwise (clockwise) at this time, the first (second) driver set 11 (12) is driven forward to push the interlocking element 1171 (1181) and the raised column 1172 (1182) is slid to the oblique guide groove at the front end of the first (second) guide groove 107 (108). The interlocking element 1171 (1181) is driven synchronically along the oblique guide groove to rotate around the point of the interlocking element 1171 (1181) pivoted with the connecting element 117 (118), as FIG. 9 shows, so that the displayer P2 takes the second (first) pivoting rod 31 (30) as a rotating center to rotate.

In the embodiment, the displayer P2 is not only rotated by the push of the first (second) driver set 11 (12) but also subjected to the synchronic push of the interlocking element 1171 (1181) so that the displayer P2 can be rotated in a larger angle by the interlocking element 1171 (1181) rotating around the point of the interlocking element 1171 (1181) pivoted with the connecting element 117 (118). Besides, an included angel θ is formed between the front part and the rear part of the interlocking element 1171 (1181), the larger the angle θ, the larger the rotating deviation degree of the displayer P2.

The display panel rotating apparatus according to the present invention allows the connecting pivoting rods at the two sides of the display panel to be the rotating centers respectively when the display panel is rotated clockwise or anticlockwise through a simple structure, and the largest rotating angle of the display panel can be attained under the situation that the display panel is pushed forward at the same distance by the driver sets through the design of the interlocking elements. Therefore, according to the display panel rotating apparatus of the present invention, the rotation effect of the display panel in a limited space can be upgraded. Besides, the assembly cost and time can be greatly reduced owing to the simple structure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rotating apparatus, being used for rotating a display panel, said display panel having a first fixing element and a second fixing element used for being connected with said rotating apparatus, said apparatus comprising:
a base;
a first driver set, movably disposed on said base and having a first connecting element; and
a second driver set, movably disposed on said base and having a second connecting element;
in which said first fixing element is pivotally connected on said first connecting element, said second fixing element is pivotally connected on said second connecting element and said first fixing element is movable relatively to said first connecting element.

2. The rotating apparatus according to claim 1, wherein one of said first connecting element and said second connecting element is taken as a rotating center to rotate said display panel.

3. The rotating apparatus according to claim 1, wherein a long-shaped hole is disposed on said first fixing element, a pivoting rod is disposed on said first connecting element, said pivoting rod is engaged in said long-shaped hole, and when said second driver set is moved to and fro, said display panel takes said pivoting rod as a rotating center to be rotated and said pivoting rod is moved in said long-shaped hole.

4. The rotating apparatus according to claim 1, wherein an axial hole is disposed on said second fixing element, said second connecting element has a pivoting rod, said pivoting rod is inserted in said axial hole, and said display panel takes said pivoting rod as a rotating center to be rotated when said first driver set is moved to and fro.

5. The rotating apparatus according to claim 1, wherein said first driver set and said second driver set further respectively have a motor and a driving gear train, said base has one pair of racks respectively engaged with said driving gear train, said motor drives said driving gear train to move said driver sets along said racks.

6. A rotating apparatus, being used for rotating a display panel, said display panel having a first fixing element and a second fixing element used for connecting said rotating apparatus, said apparatus comprising:
a base, having a first guide groove and a second guide grooves;
a first driver set, movably disposed on said base and having a first connecting element;
a second driver set, movably disposed on said base and having a second connecting element;
a first interlocking element, pivotally connected on said first connecting element, one end thereof being engaged in said first guide groove and moved along said first guide groove, another end thereof is pivotally connected to said first fixing element; and
a second interlocking element, pivotally connected on said second connecting element, one end thereof being engaged in said second guide groove and moved along said second guide groove, another end thereof is pivotally connected to said second fixing element.

7. The rotating apparatus according to claim 6, wherein a long-shaped hole is disposed on said first fixing element, a pivoting rod is disposed on said first interlocking element, said pivoting rod is engaged in said long-shaped hole, and when said second driver set is moved to and fro, said display panel takes said pivoting rod as a rotating center to be rotated and said pivoting rod is moved in said long-shaped hole.

8. The rotating apparatus according to claim 6, wherein an axial hole is disposed on said second fixing element, said second interlocking element has a pivoting rod, said pivoting rod is inserted in said axial hole, and said display panel takes said pivoting rod as a rotating center to be rotated when said first driver set is moved to and fro.

9. The rotating apparatus according to claim 6, wherein said first guide groove and said second guide groove are respectively constituted by a straight guide groove and an oblique guide groove, on end of said oblique guide groove is connected with said straight guide groove, and other ends of said obliqlue guide grooves are respectively extended toward the two sides of the base from said straight guide grooves.

10. The rotating apparatus according to claim 9, wherein said oblique guide groove is closer to the front side of said base than said straight groove.

11. The rotating apparatus according to claim 6, wherein said first driver set and said second driver set further respectively have a motor and a driving gear train, said base has one pair of racks respectively engaged with said driving gear train, said motor drives said driving gear train to move said driver sets along said racks.

12. The rotating apparatus according to claim 6, wherein said first interlocking element is movable relatively to said first connecting element.
